(19) United States
(12) Patent Application Publication
(10) Pub. No.: US 2023/0281530 A1
(43) Pub. Date: Sep. 7, 2023

(54) SYSTEMS AND METHODS FOR SCHEDULING RESOURCES

(71) Applicant: THE BOEING COMPANY, CHICAGO, IL (US)

(72) Inventors: Andriy Svynaryov, Göteborg (SE); Emily Curry, Partille (SE); Carl Fredrik Altenstedt, Mölndal (SE)

(73) Assignee: THE BOEING COMPANY, CHICAGO, IL (US)

(21) Appl. No.: 17/683,458

(22) Filed: Mar. 1, 2022

(51) Int. Cl. G06Q 10/06

(52) U.S. Cl. CPC G06Q 10/06314

(57) ABSTRACT

A system and a method include a scheduling control unit including one or more processors configured to generate scheduling options for resources of a service. The scheduling control unit is configured to analyze scheduling rules for the resources, and determine resource constraints as dictated by the scheduling rules. The scheduling control unit is configured to generate the scheduling options in accordance with the resource constraints.

### FIELD OF THE DISCLOSURE

Examples of the present disclosure generally relate to systems and methods for scheduling resources, such as personnel, aircraft, and the like for services, such as flights of aircraft between various airports.

### BACKGROUND OF THE DISCLOSURE

Aircraft are used to transport passengers and cargo between various locations. Numerous aircraft depart from and arrive at a typical airport every day.

Airline operators schedule various resources for flights over a period of time. For example, flight crews including pilots and flight attendants, aircraft, maintenance crew, and the like are scheduled for numerous flights. Various scheduling rules set limits for scheduling. As an example, pilots are limited to flying a certain number of hours in a day, a certain amount of block time (that is, the time when a block is removed from a wheel of an aircraft at a gate of an airport until a time that a block is put back on the wheel at another gate of another airport), and the like. As another example, certain maintenance procedures for an aircraft are required after a certain number of flight hours. Various scheduling rules are set by various airline operators, regulatory agencies such as the Federal Aviation Administration (FAA), labor unions, and the like. As can be appreciated, the process of scheduling hundreds of thousands of resources for different entities (including employees, vehicles, maintenance, and the like) according to hundreds if not thousands of different scheduling rules for such entities can be labor and time intensive. Indeed, such scheduling may not be able to be adequately performed by human beings, as such could take weeks if not months.

Accordingly, computers can be used to facilitate scheduling of resources. Rule Application Value Evaluator (RAVE) is a proprietary business rules engine. In particular, RAVE is a domain specific functional computer language that is used to express rules for scheduling. However, RAVE provides a narrow interface that typically checks hundreds of millions of possible scheduling options. In short, known scheduling methods generate millions of scheduling permutations that are checked against various scheduling rules using RAVE. Many of the permutations are rejected based on the rules. Such a trial and error method leads to thousands, if not millions, of rejected scheduling options, which consumes computing power and time. Indeed, a typical RAVE checking method can take days to perform, thereby consuming vast amounts of computing power.

### SUMMARY OF THE DISCLOSURE

A need exists for a system and a method for efficiently and effectively scheduling resources, such as for trips (for example, flights, train or bus journeys, and/or the like). Further, a need exists for a system and a method that improves efficiency of business rules engine methods for determining schedules.

With those needs in mind, certain examples of the present disclosure provide a system including a scheduling control unit including one or more processors configured to generate scheduling options for resources of a service. The scheduling control unit is configured to analyze scheduling rules for the resources, and determine resource constraints as dictated by the scheduling rules. The scheduling control unit is configured to generate the scheduling options in accordance with the resource constraints.

In at least one example, the resources include pilots, flight attendants, and a plurality of aircraft, and the service includes flights of the plurality of aircraft between various airports. In at least one example, the resources include personnel, equipment, and vehicles.

In at least one example, the scheduling control unit refrains from generating any scheduling option that violates the resource constraints.

In at least one example, the system also includes a user interface having an electronic display. The user interface is in communication with the scheduling control unit. The scheduling control unit is configured to show one or more of the scheduling options on the electronic display.

In at least one example, the resource constraints include one or both of upper limits or lower limits.

In at least one example, the scheduling control unit is configured to determine the resource constraints by analyzing an abstract syntax tree of business engine scheduling source code, identifying additive rules, and generating resource constraint definitions as business engine scheduling expressions. In at least one example, the scheduling control unit is further configured to parse the abstract syntax tree and check dependency of rule conditions as well as the dependencies of variables.

In at least one example, the scheduling control unit is further configured to generate code for the resource constraints by parsing abstract syntax trees for the scheduling rules.

Certain examples of the present disclosure provide a method including analyzing, by a scheduling control unit including one or more processors, scheduling rules for resources of a service; determining, by the scheduling control unit, resource constraints as dictated by the scheduling rules; and generating, by the scheduling control unit, scheduling options for the resources in accordance with the resource constraints.

Certain examples of the present disclosure provide a non-transitory computer-readable storage medium comprising executable instructions that, in response to execution, cause one or more control units comprising a processor, to perform operations comprising: analyzing scheduling rules for resources of a service; determining resource constraints as dictated by the scheduling rules; and generating scheduling options for the resources in accordance with the resource constraints.

### BRIEF DESCRIPTION OF THE DRAWINGS

FIG. 1 illustrates a schematic block diagram of a system for scheduling resources, according to an example of the present disclosure.

FIG. 2 illustrates a flow chart of a method for scheduling resources, according to an example of the present disclosure.

FIG. 3 illustrates a chart of execution time in relation to cost for a system for scheduling resources, according to an example of the present disclosure.

FIG. 4 illustrates a chart of execution time in relation to cost for a system for scheduling resources, according to an example of the present disclosure.

FIG. 5 illustrates a perspective front view of an aircraft, according to an example of the present disclosure.

FIG. 6 illustrates a flow chart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

In at least one example, systems and methods are configured to generate scheduling options for resources of a service. The resources can be individuals, such as members of a flight crew (for example, pilots). The resources can be scheduled. For example, a specific individual can be scheduled. A resource constraint relates to the resource. For example, a resource constraint for a pilot can be block time in a predetermined time period (such as a month), number of flights flown in a predetermined time period, and the like.

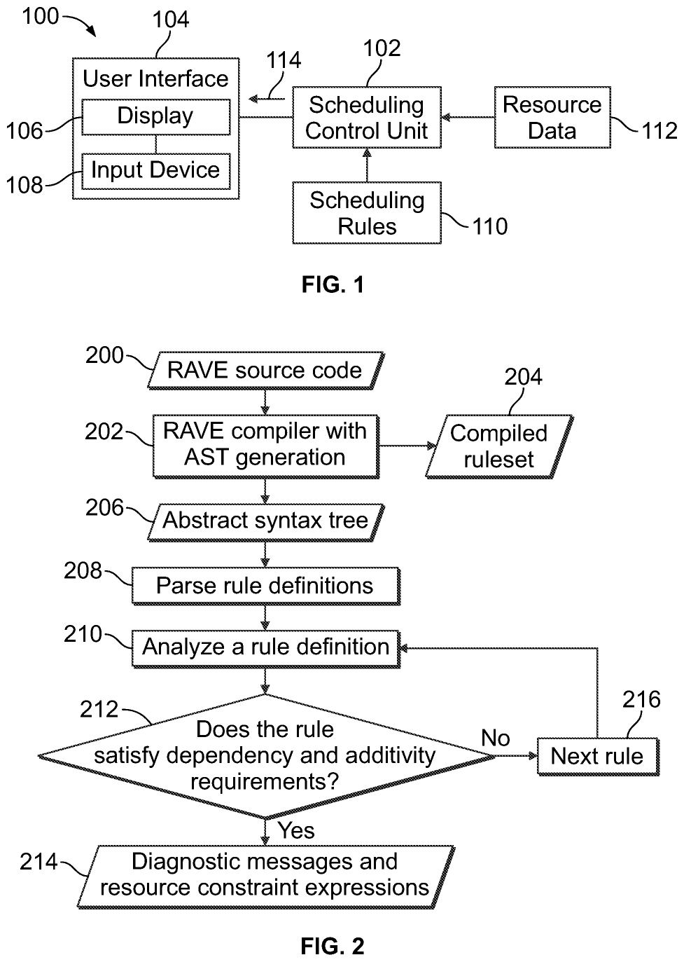

FIG. 1 illustrates a schematic block diagram of a system 100 for scheduling resources, according to an example of the present disclosure. Examples of the resources including personnel, equipment, vehicles, and/or the like. For example, the personnel can be pilots and flight attendants for an aircraft. As another example, the personnel can be operators of vehicles, such as trains, buses, or the like. As another example, the personnel can be medical staff within one or more medical facilities, such as hospitals. As another example, the personnel can be wait staff at restaurants.

The system 100 includes a scheduling control unit 102 in communication with a user interface 104, such as through one or more wired or wireless connections. The user interface 104 includes a display 106, such as an electronic monitor or screen, television, or the like, and an input device 108, such as may be or include a keyboard, mouse, stylus, touchscreen interface, and/or the like. In at least one example, the user interface 104 is part of a computer workstation, such as can include the scheduling control unit 102. As another example, the user interface 104 can be a handheld device, such as a smart phone, smart tablet, or the like.

The scheduling control unit 102 receives scheduling rules 110 and resource data 112. The scheduling rules 110 and the resource data 112 can be input into the scheduling control unit 102, such as via the user interface 104, another computer, and/or the like. In at least one example, the scheduling control unit 102 receives the scheduling rules 110 and the resource data 112 from a network, such as a private network, a public network, the Internet, and/or the like.

The resource data 112 includes data regarding all of the resources that are to be scheduled. Examples of the resources include human beings, such as vehicle operators (such as pilots and flight attendants), maintenance crew, vehicles, and/or the like.

The scheduling rules 110 include resource constraints (for example, upper and/or lower limits) for scheduling the resources. As an example, a scheduling rule 110 is a certain amount of block time that can be flown by a pilot in a day. For example, a scheduling rule 110 dictates that a pilot cannot fly more than 8 hours of block time in a day. As another example, a scheduling rule 110 is a pilot can fly a certain number of flight legs (such as four) in a day. As another example, a scheduling rule 110 is that a pilot must fly a certain number of flights in a given month (such as at least five flights per month). The scheduling rules 110 can be determined by a particular entity, such as an airline operator, a regulator agency, such as the FAA, a labor union, and/or the like. The scheduling rules 110 can be determined by multiple entities and dictate upper and/or lower limits for various aspects for scheduling the resources.

In operation, the scheduling control unit 102 analyzes the scheduling rules 110 to identify the various resource constraints embedded within or otherwise part of the scheduling rules 110. As noted, the limits can be upper limits (for example, a pilot cannot log more than 8 hours of block time in a day), and/or lower limits (for example, a pilot must fly at least five flights in a month). The scheduling control unit 102 identifies the various limits within the scheduling rules 110. After determining the various limits within the scheduling rules 110, the scheduling control unit 102 applies the scheduling rules to the resource data 112 to determine various schedule options for the resources as set forth in the resource data 112. However, by identifying the limits within the scheduling rules 110, the scheduling control unit 102 refrains from generating schedule options that violate (for example, are in excess of upper limits or are below lower limits) the limits. In this manner, the scheduling control unit 102 efficiently determines the schedule options in a much faster manner than if all possible scheduling permutations were generated. As such, computing time and power are conserved, and the scheduling control unit 102 vastly improves the efficiency and operation of a business rules engine, such as RAVE.

Prior to the systems and methods described herein, due to size and complexity, runtimes for computer-based scheduling could be several days for a large crew group. A known method generates new rosters by finding shortest paths in a trip network. However, some shortest paths do not comply with permissible rules. An allowability rate (that is, the rate at which a path is permissible according to a rule) can be increased by augmenting a trip network with resource constraints that correspond to additive permissibility rules. Typically, resource constraints are written manually in RAVE as a part of customer specific configuration. Finding suitable rules and deducing the constraints is a challenging and error-prone task. Accordingly, examples of the present disclosure provide systems and methods (such as the system 100 shown in FIG. 1) automatically detect additive rules through static RAVE code analysis, and then generate new source code for the corresponding resource constraint.

The system 100 achieves computational performance and flexibility. Column generation is a known method for solving a weighted fair share rostering problem. One of the steps of the method is generating new rosters by finding shortest paths in a trip network. After finding a shortest path in the network, an optimizer checks the permissibility of the corresponding roster (in relation to predefined rules). If the roster is permissible, a new path is generated, but this time with impermissible paths excluded. However, solving the shortest path problem several times to get a permissible roster decreases performance considerably.

To avoid impermissible paths, the scheduling control unit 102 is augmented with resource constraints which correspond to RAVE rules. The resource constraints are limits (either upper or lower limits) identified in the rules. Scheduling options that violate (for example, exceeding an upper limit or being less than a lower limit) are not generated by the scheduling control unit 102. Not every rule can be expressed as a resource constraint, but a significant portion can. As an example, the rule satisfies the following: First, the rule condition has a form left_hand_side and right_hand_side. Second, the expressions for right_hand_side and rule validity may depend on a crew and a bid group, but may not depend on a roster or trips in the roster. Third, the expression for left_hand_side may not depend on a crew or a bid group, but should be additive over trips in the roster (for example, consumption of a roster is a sum of the consumptions of trips in the roster). A special case is an edge resource constraint, where left_hand_side does not have to be additive over trips, but is additive over edges (connections between two adjacent trips).

Examples of the present disclosure provide systems and methods for solving complex crew resource optimization problems in a computationally efficient manner using resource constraints combined with a business rules engine, such as RAVE. The systems and methods described herein address the currently resource-heavy and manual process of identifying and implementing customer-specific resource constraints for crew resource optimization.

In at least one example, the scheduling control unit 102 is configured to determine the resource constraints by analyzing an abstract syntax tree of business engine scheduling source code, identify additive rules, and generate resource constraint definitions as business engine scheduling expressions. For example, the scheduling control unit 102 analyzes an abstract syntax tree of business engine scheduling source code (such as RAVE source code), finds additive rules and generates resource constraint definitions as RAVE expressions. In at least one example, the scheduling control unit 102 parses the abstract syntax tree of each RAVE rule. The scheduling control unit 102 parses the syntax tree and checks the dependency of the rule condition as well as the dependencies of the RAVE variables used in the rule. If the condition statement and the RAVE variables fulfill the conditions, the rule can be written as a resource constraint. Next, the scheduling control unit 102 generates the RAVE code for the identified resource constraints by parsing the abstract syntax trees for the identified rules and translating them back to RAVE code.

In at least one example, the scheduling control unit 102 outputs scheduling data 114 to the user interface 104. The scheduling data 114 includes the scheduling options for the resources identified in the resource data 112. The user interface 104 may show at least portions of the scheduling data 114 on the display 106. The user interface 104 has an electronic display 106. The user interface is in communication with the scheduling control unit 102. The scheduling control unit 102 is configured to show one or more of the scheduling options on the electronic display 106.

Various operations can be automatically performed based on selected scheduling options. For example, aircraft can be automatically staffed and/or operated based on schedules from the scheduling options, as determined by the scheduling control unit 102. In at least one example, the scheduling control unit 102 automatically selects schedules from the scheduling options based on one or more parameters (for example, lowest cost of labor, regular number of work days for all personnel, least amount of off time, and/or the like). In at least one example, the scheduling control unit 102 automatically selects schedules from the scheduling options for all of the resources and one or more systems, such as vehicles, having one or more operations that are automatically operated based on the automatically selected schedules. Optionally, the scheduling control unit 102 may not automatically select schedules from the scheduling options. Also, optionally, operations may not be automatically performed based on selected schedules.

As described herein, the system 100 includes a scheduling control unit 102 configured to generate scheduling options for resources of a service, such as flight crew, maintenance crew, gate agents, and the like of flights of aircraft. For example, the resources include pilots, flight attendants, and a plurality of aircraft, and the service includes flights of the plurality of aircraft between various airports. The scheduling control unit 102 is configured to analyze scheduling rules for the resources, and determine resource constraints as dictated by the scheduling rules. The resource constraints include one or both of upper limits or lower limits of the scheduling rules. The scheduling control unit 102 generates the scheduling options in accordance with the resource constraints. That is, the scheduling control unit 102 refrains from generating any scheduling option that violates the resource constraints.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the scheduling control unit 102 may be or include one or more processors that are configured to control operation, as described herein.

The scheduling control unit 102 is configured to execute a set of instructions that are stored in one or more data storage units or elements (such as one or more memories), in order to process data. For example, the scheduling control unit 102 may include or be coupled to one or more memories. The data storage units may also store data or other information as desired or needed. The data storage units may be in the form of an information source or a physical memory element within a processing machine.

The set of instructions may include various commands that instruct the scheduling control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the scheduling control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the scheduling control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

FIG. 2 illustrates a flow chart of a method for scheduling resources, according to an example of the present disclosure. Referring to FIGS. 1 and 2, at 200, RAVE source code is generated. The scheduling control unit 102 receives RAVE source code at 202. In at least one example, the scheduling control unit 102 includes a RAVE complier with abstract syntax tree generation. At 204, the scheduling control unit 102 generates a complied ruleset.

At 206, the scheduling control unit 102 analyzes the abstract syntax tree of the RAVE source code to identify rule definitions (that is, the rules). At 208, the scheduling control unit 102 parses the rule definitions. At 210, the scheduling control unit analyzes a rule definition 210. At 212, the scheduling control unit 102 determines if the rule satisfies dependency and additivity requirements. For example, an additivity requirement is in relation to an upper limit. As an example, a rule requires that a pilot does not exceed 8 hours block time in a day. As another example, a rule requires at least 5 flights in a month. As another example, a rule requires no more than 4 flight legs in a day. If, at 212, the rules satisfied dependency and additivity requirements, the method proceeds to 214, at which the scheduling control unit 102 outputs diagnostic messages, and resource constraint expressions. If, however, the rule does not satisfy the additivity and dependency requirements, the method proceeds to 216, at which the scheduling control unit analyzes the next rule, and the method returns to 210.

A dependency rule relates to what a specific expression depends upon. For example, block time is summed for each trip in a predetermined time period, such as a month. The block time of each trip depends only on the trip itself and the rule can be expressed as a resource constraint. As another example, an individual may fly at most two night trips in a month. A trip is considered a night trip if an individual works across a predefined time in personal acclimatised time (commonly called one's body clock). The personal acclimatised time is a function of the time of nightly rest for a past week. Even though the rule can be expressed as a sum of a per trip value, the value that is summed (if a trip is considered a night trip) depends on more than the trip itself or its immediate predecessor. Hence, the trip value may not be pre-computed as it depends on the surrounding schedule and cannot be expressed as a sum of something purely trip-dependent. Therefore, such rule cannot be expressed as a simple additive resource constraint.

As shown and described, in at least one example, the scheduling control unit 102 analyzes the abstract syntax tree of business engine scheduling source code (such as RAVE source code), identifies additive rules, and generates resource constraint definitions as business engine scheduling (for example, RAVE) expressions. In at least one example, the scheduling control unit 102 parses the abstract syntax tree of each business engine scheduling (for example, RAVE) rule. The scheduling control unit 102 parses the abstract syntax tree and checks the dependency of the rule condition as well as the dependencies of business engine scheduling variables used in the rule. If the condition statement and the business engine scheduling variables fulfill predefined conditions, the rule can be written as a resource constraint. In a final step, the scheduling control unit 102 generates code for the identified resource constraints by parsing the abstract syntax trees for the identified rules and translating them back to the business engine scheduling source code.

Examples of the subject disclosure provide systems and methods that allow large amounts of data to be quickly and efficiently analyzed by a computing device. For example, the scheduling control unit 102 can analyze various aspects of resources and scheduling rules. As such, large amounts of data, which may not be discernable by human beings, are being tracked and analyzed. The vast amounts of data are efficiently organized and/or analyzed by the scheduling control unit 102, as described herein. The scheduling control unit 102 analyzes the data in a relatively short time in order to quickly and efficiently determine scheduling options in a relatively short time. A human being would be incapable of efficiently analyzing such vast amounts of data in such a short time. As such, examples of the subject disclosure provide increased and efficient functionality, and vastly superior performance in relation to a human being analyzing the vast amounts of data.

Identifying rules satisfying various requirements (for example, upper and lower limits), and writing corresponding resource constraints is a non-trivial, time-consuming and error-prone task for humans, yet essential to get maximum performance in relation to a column generation method. Very few people have the required skills to effectively perform such tasks. The systems and methods described herein automatically (that is, without human intervention), efficiently, and effectively perform such tasks.

In at least one embodiment, components of the system 100, such as the scheduling control unit 102, provide and/or enable a computer system to operate as a special computer system for determining schedules for resources. The scheduling control unit 102 greatly improves upon business engine scheduling software by greatly decreasing computing time and power to determine schedules for various resources.

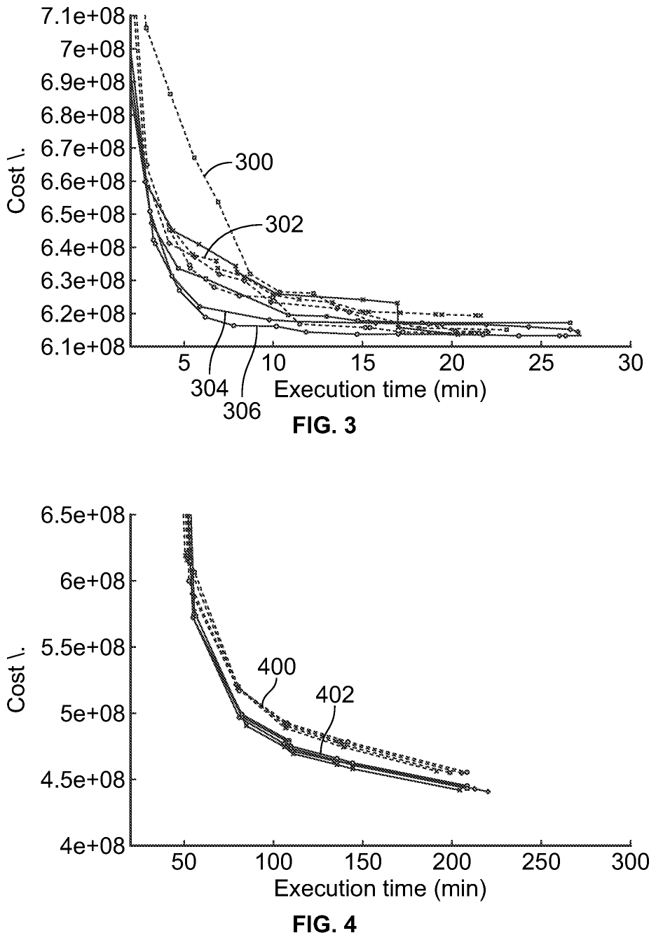

FIG. 3 illustrates a chart of execution time in relation to cost for a system for scheduling resources, according to an example of the present disclosure. As shown in FIGS. 3, examples of the present disclosure provide systems and methods that vastly improve time and costs by adding identified resource constraints to the model. The curves 300 and 302, for example, correspond to different permutations of the same run (that is, they use different random seeds which typically result in different solution paths). The curves 304 and 306, for example, correspond to the same runs but with the resource constraints generated by the scheduling control unit 102. It has been found that adding resource constraints provides better solutions faster (notably, the curves 304 and 306 are below the curves 300 and 302).

FIG. 4 illustrates a chart of execution time in relation to cost for a system for scheduling resources, according to an example of the present disclosure. The curves 400 correspond to runs where no resource constraints are used. The curves 402 correspond to runs in which resources constraints (for example, limits identified in the rules—scheduling options that violate such limits are not generated) are added by the scheduling control unit 102. It has been found that the scheduling control unit 102 determining the resource constraints (that is, the limits of the rules), and using such resource constraints when determining scheduling options provides better solutions.

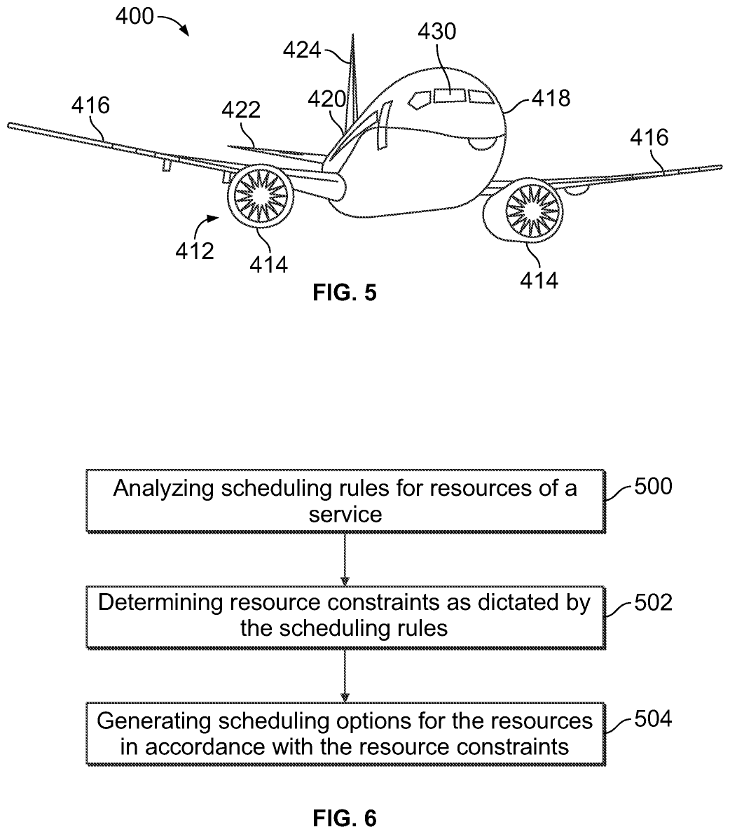

FIG. 5 illustrates a perspective front view of an aircraft 400, according to an example of the present disclosure. The aircraft 400 includes a propulsion system 412 that includes engines 414, for example. Optionally, the propulsion system 412 may include more engines 414 than shown. The engines 414 are carried by wings 416 of the aircraft 400. In other embodiments, the engines 414 may be carried by a fuselage 418 and/or an empennage 420. The empennage 420 may also support horizontal stabilizers 422 and a vertical stabilizer 424. The fuselage 418 of the aircraft 400 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 5 shows an example of an aircraft 400. It is to be understood that the aircraft 400 can be sized, shaped, and configured differently than shown in FIG. 5.

Referring to FIGS. 1-5, and the scheduling control unit 102 is configured to determine scheduling options for flights of various aircraft, such as the aircraft 400. The scheduling control unit 102 can schedule resources for hundreds or more aircraft. The aircraft 400 itself can be a resource identified in the resource data. One or more scheduling rules can apply to the aircraft, such as total flight time in a predefined period of time, flight time until a particular maintenance operation, and/or the like.

In at least one other example, the scheduling control unit 102 is configured to determine scheduling options for trips of various other vehicles, such as trains, buses, watercraft, spacecraft, and/or the like. In at least one other example, the scheduling control unit 102 is configured to determine scheduling options for various other settings, such as staffing within businesses, hospitals, and/or the like.

FIG. 6 illustrates a flow chart of a method, according to an example of the present disclosure. The method includes analyzing 500, by a scheduling control unit including one or more processors, scheduling rules for resources of a service; determining 502, by the scheduling control unit, resource constraints as dictated by the scheduling rules; and generating 504, by the scheduling control unit, scheduling options for the resources in accordance with the resource constraints.

Further, the disclosure comprises examples according to the following clauses:

Clause 1. A system comprising:

a scheduling control unit including one or more processors configured to generate scheduling options for resources of a service, wherein the scheduling control unit is configured to analyze scheduling rules for the resources, and determine resource constraints as dictated by the scheduling rules, and wherein the scheduling control unit is configured to generate the scheduling options in accordance with the resource constraints.

Clause 2. The system of Clause 1, wherein the resources comprise pilots, flight attendants, and a plurality of aircraft, and wherein the service includes flights of the plurality of aircraft between various airports.

Clause 3. The system of Clauses 1 or 2, wherein the resources comprise personnel, equipment, and vehicles.

Clause 4. The system of any of Clauses 1-3, wherein the scheduling control unit refrains from generating any scheduling option that violates the resource constraints.

Clause 5. The system of any of Clauses 1-4, further comprising a user interface having an electronic display, wherein the user interface is in communication with the scheduling control unit, and wherein the scheduling control unit is configured to show one or more of the scheduling options on the electronic display.

Clause 6. The system of any of Clauses 1-5, wherein the resource constraints include one or both of upper limits or lower limits.

Clause 7. The system of any of Clauses 1-6, wherein the scheduling control unit is configured to determine the resource constraints by analyzing an abstract syntax tree of business engine scheduling source code, identifying additive rules, and generating resource constraint definitions as business engine scheduling expressions.

Clause 8. The system of Clause 7, wherein the scheduling control unit is further configured to parse the abstract syntax tree and check dependency of rule conditions as well as the dependencies of variables.

Clause 9. The system of any of Clauses 1-8, wherein the scheduling control unit is further configured to generate code for the resource constraints by parsing abstract syntax trees for the scheduling rules.

Clause 10. A method comprising:

analyzing, by a scheduling control unit including one or more processors, scheduling rules for resources of a service;

determining, by the scheduling control unit, resource constraints as dictated by the scheduling rules; and

generating, by the scheduling control unit, scheduling options for the resources in accordance with the resource constraints.

Clause 11. The method of Clause 10, wherein the resources comprise pilots, flight attendants, and a plurality of aircraft, and wherein the service includes flights of the plurality of aircraft between various airports.

Clause 12. The method of Clauses 10 or 11, wherein the resources comprise personnel, equipment, and vehicles.

Clause 13. The method of any of Clauses 10-12, wherein said generating the scheduling options comprises refraining from generating any scheduling option that violates the resource constraints.

Clause 14. The method of any of Clauses 10-13, further comprising showing, by the scheduling control unit, one or more of the scheduling options on an electronic display of a user interface.

Clause 15. The method of any of Clauses 10-14, wherein the resource constraints include one or both of upper limits or lower limits.

Clause 16. The method of any of Clauses 10-15, wherein said determining the resource constraints comprises:
analyzing an abstract syntax tree of business engine scheduling source code;
identifying additive rules; and
generating resource constraint definitions as business engine scheduling expressions.

Clause 17. The method of Clause 16, further comprising:
parsing, by the scheduling control unit, the abstract syntax tree; and
checking, by the scheduling control unit, dependency of rule conditions as well as the dependencies of variables.

Clause 18. The method of any of Clauses 10-17, further comprising generating, by the scheduling control unit, code for the resource constraints by parsing abstract syntax trees for the scheduling rules.

Clause 19. A non-transitory computer-readable storage medium comprising executable instructions that, in response to execution, cause one or more control units comprising a processor, to perform operations comprising:
analyzing scheduling rules for resources of a service;
determining resource constraints as dictated by the scheduling rules; and
generating scheduling options for the resources in accordance with the resource constraints.

Clause 20. The non-transitory computer-readable storage medium of Clause 19, wherein said generating the scheduling options comprises refraining from generating any scheduling option that violates the resource constraints.

As described herein, examples of the present disclosure provide systems and methods for efficiently and effectively scheduling resources, such as for trips (for example, flights, train or bus journeys, and/or the like). Further, examples of the present disclosure provide systems and methods that improve efficiency of business rules engine methods for determining schedules.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a scheduling control unit including one or more processors configured to generate scheduling options for resources of a service, wherein the scheduling control unit is configured to analyze scheduling rules for the resources, and determine resource constraints as dictated by the scheduling rules, and wherein the scheduling control unit is configured to generate the scheduling options in accordance with the resource constraints.

2. The system of claim 1, wherein the resources comprise pilots, flight attendants, and a plurality of aircraft, and wherein the service includes flights of the plurality of aircraft between various airports.

3. The system of claim 1, wherein the resources comprise personnel, equipment, and vehicles.

4. The system of claim 1, wherein the scheduling control unit refrains from generating any scheduling option that violates the resource constraints.

5. The system of claim 1, further comprising a user interface having an electronic display, wherein the user interface is in communication with the scheduling control unit, and wherein the scheduling control unit is configured to show one or more of the scheduling options on the electronic display.

6. The system of claim 1, wherein the resource constraints include one or both of upper limits or lower limits.

7. The system of claim 1, wherein the scheduling control unit is configured to determine the resource constraints by analyzing an abstract syntax tree of business engine scheduling source code, identifying additive rules, and generating resource constraint definitions as business engine scheduling expressions.

8. The system of claim 7, wherein the scheduling control unit is further configured to parse the abstract syntax tree and check dependency of rule conditions as well as the dependencies of variables.

9. The system of claim 1, wherein the scheduling control unit is further configured to generate code for the resource constraints by parsing abstract syntax trees for the scheduling rules.

10. A method comprising:
analyzing, by a scheduling control unit including one or more processors, scheduling rules for resources of a service;
determining, by the scheduling control unit, resource constraints as dictated by the scheduling rules; and
generating, by the scheduling control unit, scheduling options for the resources in accordance with the resource constraints.

11. The method of claim 10, wherein the resources comprise pilots, flight attendants, and a plurality of aircraft, and wherein the service includes flights of the plurality of aircraft between various airports.

12. The method of claim 10, wherein the resources comprise personnel, equipment, and vehicles.

13. The method of claim 10, wherein said generating the scheduling options comprises refraining from generating any scheduling option that violates the resource constraints.

14. The method of claim 10, further comprising showing, by the scheduling control unit, one or more of the scheduling options on an electronic display of a user interface.

15. The method of claim 10, wherein the resource constraints include one or both of upper limits or lower limits.

16. The method of claim 10, wherein said determining the resource constraints comprises:
analyzing an abstract syntax tree of business engine scheduling source code;
identifying additive rules; and
generating resource constraint definitions as business engine scheduling expressions.

17. The method of claim 16, further comprising:
parsing, by the scheduling control unit, the abstract syntax tree; and
checking, by the scheduling control unit, dependency of rule conditions as well as the dependencies of variables.

18. The method of claim 10, further comprising generating, by the scheduling control unit, code for the resource constraints by parsing abstract syntax trees for the scheduling rules.

19. A non-transitory computer-readable storage medium comprising executable instructions that, in response to execution, cause one or more control units comprising a processor, to perform operations comprising:
analyzing scheduling rules for resources of a service;
determining resource constraints as dictated by the scheduling rules; and
generating scheduling options for the resources in accordance with the resource constraints.

20. The non-transitory computer-readable storage medium of claim 19, wherein said generating the scheduling options comprises refraining from generating any scheduling option that violates the resource constraints.
